(19) United States
(12) Patent Application Publication
(10) Pub. No.: US 2002/0194619 A1
(43) Pub. Date: Dec. 19, 2002

(54) System and method for electronic music video download

(76) Inventors: Matthew S. Chang, San Diego, CA (US); Aditya Krishnan, San Diego, CA (US); Andrew M. Proehl, San Francisco, CA (US); David K.L. Yang, San Jose, CA (US); Frederick J. Zustak, Poway, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: FROMMER LAWRENCE & HAUG LLP, 745 FIFTH AVENUE, NEW YORK, NY, 10151, US

(21) Appl. No.: 09/882,996

(22) Filed: Jun. 14, 2001

(51) Int. Cl. H04N 7/173; H04N 5/445

(52) U.S. Cl. 725/134; 725/39; 725/109

(57) ABSTRACT

A set top box includes a designation function that provides a user with the ability to designate and store music video clips that the user is currently viewing while watching a video music channel. The user can instantly select a viewed video for storage in its entirety even after it has begun. The videos may be stored on a hard disk drive of the set top box, and may be indexed or organized by titles, artists, genre, or the like. Additionally, a user may be listening to an audio program on an audio cable channel, a radio channel, a digital or analog stereo (e.g., playback from a CD), and upon selection of a particular song, a corresponding video is downloaded to the user's designated set top box.

### BACKGROUND OF THE INVENTION

1. Field of the Invention

The present invention relates to a system and method for providing a user with the ability to store music videos clip that the user is viewing on a video music channel.

2. Description of the Related Art

Video Cassette Recorders (“VCRs”) have been used for recording television programs. A VCR records video signals onto a magnetic tape encased in a cassette that is removable from the VCR. A user may directly control a VCR to record a television program while the user is viewing the program. Alternatively, the user may program the VCR with start times, end times, and channels for automatically recording programs that are scheduled to be broadcast at those times and channels.

Recently, programmable digital video recorders using integrated high capacity storage media, such as hard disks, have been in development. Such a recorder, e.g. a TiVo™ recorder, allows a user to select multiple television programs for recording. The recorder stores and regularly updates television programming schedules and other information through a modem connection. The information is provided to the user for selecting programs to be recorded, and the selected programs are automatically recorded at the scheduled broadcast times and channels.

### OBJECTS OF THE INVENTION

Although the above-described recorders provide convenience in recording television programs for subsequent viewing, they only record when instructed by control or pre-programmed to record selected programs. Namely, the above-described recorders do not provide retrieval and storage of a clip of a program segment, in its entirety, after it has begun. Additionally, the designation of audio or video data from another source, such as an emarker, compact disc (“CD”), radio, and other playback media, for eventually downloading corresponding data to a set-top box (“STB”) for storage is not provided.

Therefore, it is an object of the present invention to provide for designating audio and/or video data while it is being presented and recording the entire set of data including multimedia data related to the designated set.

Other objects and advantages of the invention will in part be obvious and will in part be apparent from the specification and the drawings.

### SUMMARY OF THE INVENTION

The present invention is directed to a system and method that provides a user with the ability to store music videos that the user is currently viewing while watching a video music channel. The user can instantly select a viewed video for storage, in its entirety, even after it has begun. The videos may be stored on a hard disk drive of an STB, and may be indexed or organized by titles, artists, genre, or the like. Additionally, a user may be listening to an audio program on an audio cable channel, a radio channel, a digital or analog stereo (e.g., playback from a CD), and upon selection of a particular song, a corresponding video is downloaded to the user's designated STB. Finally, the apparatus may be used with the emarker (manufactured and marketed by Sony™ Corporation; a description of the emarker is provided in U.S. patent application Ser. No. ______, filed on ______, the entire contents of which are incorporated herein by reference). After storing all of the markers, the index may be used not only to download the marked songs for purchase, but also allow for the download of a corresponding music video to the STB. In addition to providing the music videos, other related multimedia data may be downloaded based upon a combination of similarities and user preferences, or prior user selections.

The invention accordingly comprises the several steps and the relation of one or more of such steps with respect to each of the others, and the apparatus embodying features of construction, combination(s) of elements and arrangement of parts that are adapted to effect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawing(s), in which:

FIG. 1 illustrates the overall system configuration in accordance with an embodiment of the present invention;

FIG. 2 illustrates the internal structure of the set-top box shown in FIG. 1;

FIG. 3 is a flow chart for explaining a process of designating and downloading a presented program segment in accordance with an embodiment of the invention; and

FIG. 4 is a flow chart for explaining a process of identifying and downloading a segment/clip based upon a designation of related data in accordance with an embodiment of the invention.

### DETAILED DESCRIPTION OF PREFERRED EMBODIMENTS

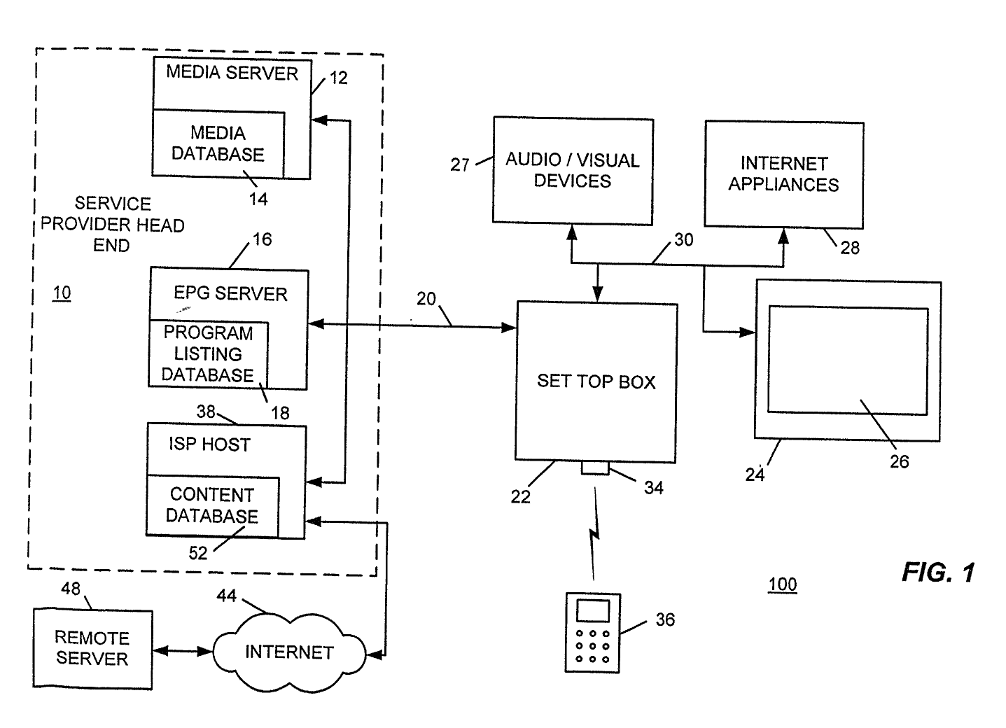

FIG. 1 shows a block diagram for an interactive cable or satellite television (“TV”) system 100 in accordance with an embodiment of the present invention. System 100 includes, at a service provider head end (“HE”) 10, a media server 12 for providing, on demand, movies, music, music videos, and other programming obtained from a media database 14. Media server 12 may also provide additional content, such as, artist interviews, games, advertisements, available merchandise, associated Web pages, interactive games, and other related content. System 100 may also include an electronic programming guide (“EPG”) server 16 and a program listing database 18 for generating an EPG. An STB 22 may provide for bi-directional communication with HE 10 (and media server 12 and EPG server 16) over a transmission medium 20 (e.g., a cable STB). Transmission medium 20 may include, for example, a coaxial cable network, a fiber optic cable network, a telephone system, a twisted pair, a satellite communication system, a radio frequency (“RF”) system, a microwave system, other wireless systems, a combination of wired and wireless systems, or any of a variety of known electronic transmission media. In the case of a cable television network, transmission medium 20 may be realized at a subscriber's premises as a coaxial cable that is connected to a suitable cable connector at the rear panel of STB 22. In the case of a Direct Satellite System (“DSS”), STB 22 may be referred to as an Integrated Receiver Decoder (“IRD”), and the transmission medium may be a satellite transmission at an appropriate microwave band. Such transmissions may be typically received by a satellite dish antenna with an integral Low Noise Block (“LNB”) that serves as a down-converter to convert the signal to a lower frequency for processing by STB 22. Thus, the bi-directional communications between HE 10 and STB 22 may be effected using asymmetrical communication techniques or dual communication media—one for the uplink from STB 22 to HE 10 and one for the downlink from HE 10 to STB 22. In any event, STB 22 may include its own Universal Resource Locator (“URL”) assigned thereto to provide for addressability by HE 10 and users of the Internet 44.

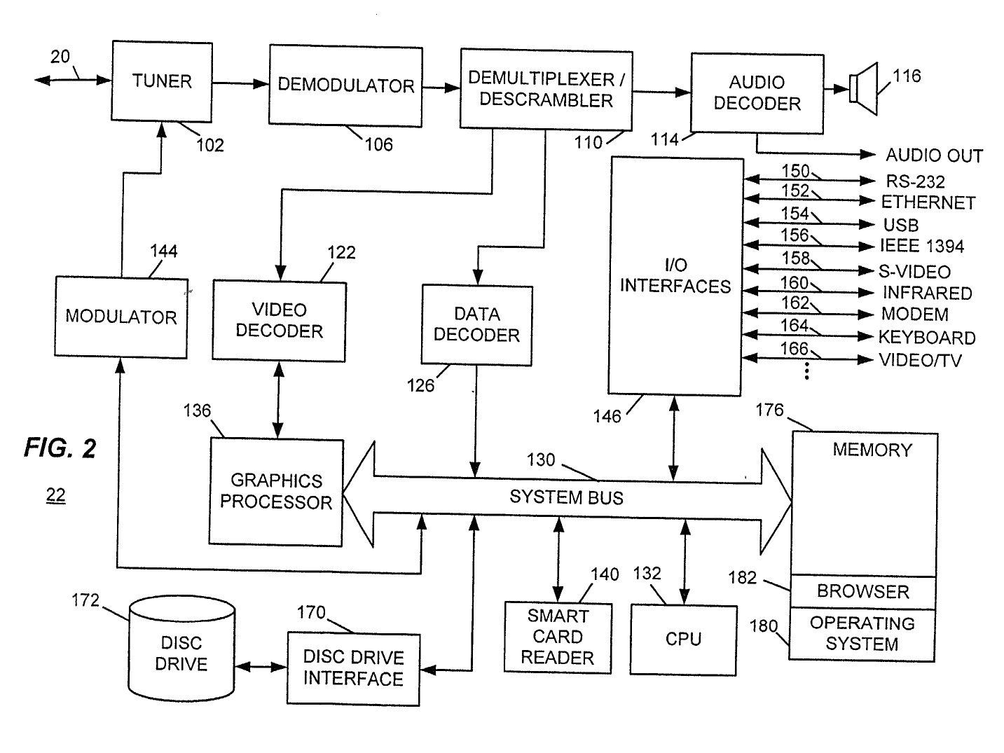

As shown in FIG. 1, system 100 further includes a TV 24, such as a digital television, having a display 26 for displaying programming, an EPG, etc. STB 22 may be coupled to TV 24 and various other audio/visual (“A/V”) devices 27 and Internet Appliances 28 by an interface 30, which may be any suitable analog or digital interface. In accordance with an embodiment of the invention, interface 30 conforms to the Institute of Electrical and Electronics Engineers (“IEEE”) 1394 (so-called “firewire” or “i-link”) standard. STB 22 may include a central processing unit (“CPU”) and memory including Random Access Memory (“RAM”), Read Only Memory (“ROM”), flash memory, and mass storage media (such as a hard disk drive, floppy disk drive, optical disc drive, other electronic storage media, etc.), as will be described below with reference to FIG. 2. Such memory and storage media are suitable for storing data as well as instructions for programmed processes for execution on the CPU, as will be discussed later. Information and programs stored on the storage media or memory may also be transported over transmission medium 20. STB 22 may further include circuitry suitable for audio decoding and processing, the decoding of video data compressed in accordance with a compression standard such as the Motion Pictures Experts Group (“MPEG”) standard, and other processing to form a controller or central hub. Components of STB 22 may also be incorporated into TV 24 itself, thus eliminating STB 22. Further, a computer having a tuner device may be equivalently substituted for TV 24 and STB 22.

By way of example, A/V devices 27 and Internet Appliances 28 may include a personal computer (“PC”), VCR, camcorder, digital camera, personal digital assistant (“PDA”), and other A/V or Internet-related devices. In addition, interface 30 may include a data transport architecture, such as that set forth by an industry group which includes Sony Corporation and known as the Home Audio-Video Interoperability (“HAVi”) architecture, thus enabling interoperability among devices on a network regardless of the manufacturer of the device. Such an architecture forms a home network system wherein electronic devices (e.g., A/V devices 27) and Internet appliances 28 are compatible with each other. In accordance with an embodiment of invention, STB 22 runs an operating system suitable for a home network system such as Sony Corporation's Aperios™ real time operating system. Other operating systems may also be used.

STB 22 includes an infrared (“IR”) receiver 34 for receiving IR signals from an input device 36, such as a remote control. Other control communication methods may also be utilized, such as wired or wireless RF, etc. In addition, it can be readily appreciated that input device 36 may be any device suitable for controlling STB 22, such as a remote control, PDA, laptop computer, keyboard, or computer mouse, etc. In addition, an input device in the form of a control panel located on TV 24 or STB 22 may be provided.

STB 22 may also be coupled to an independent service provider (“ISP”) host 38 by a suitable connection, such as a dial-up connection, Digital Subscriber Line (“DSL”) or transmission medium 20 described above (e.g., using a cable modem), to provide access to services and content from ISP host 38 and Internet 44. ISP host 38 provides various content to STB 22, which may be obtained from a content database 42. STB 22, thus, may also be used as an Internet access device to obtain information and content from remote servers, such as remote server 48, via Internet 44 using ISP host 38 operating as an Internet portal, for example. In certain satellite STB environments, the data may be downloaded at very high speeds from a satellite link, with asymmetrical upload speed from STB 22 provided via a dial-up or DSL connection.

Referring now to FIG. 2, a system configuration for STB 22 is illustrated. In accordance with an embodiment of the invention, transmission medium 20, such as a coaxial cable, is coupled by a suitable interface to a tuner 102. Tuner 102 may, for example, include a broadcast in-band tuner for receiving content, an out-of-band (“OOB”) tuner for receiving data transmissions, and a return path tuner for providing an OOB return path for outbound data (destined, for example, for HE 10). A separate tuner (not shown) may be provided to receive RF broadcast television channels and radio channels, etc. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (“PID”) that identifies the packet as containing a particular type of data (e.g. audio, video, data). Demultiplexer and descrambler circuit 110 may also decrypt encrypted information in accordance with a decryption algorithm to prevent unauthorized access to programming content, for example.

Audio packets from demultiplexer and descrambler circuit 110 (those identified with an audio PID) are decrypted and forwarded to an audio decoder 114 where they may be converted to analog audio to drive a speaker system or other audio system 116 (e.g. stereo or home theater multiple channel amplifier and speaker systems) or may simply provide decoded audio to an AUDIO OUT port 118. Video packets from demultiplexer and descrambler circuit 110 (those identified with a video PID) are decrypted and forwarded to a video decoder 122. In a similar manner, data packets from demultiplexer and descrambler circuit 110 (those identified with a data PID) are decrypted and forwarded to a data decoder 126.

Decoded data packets from data decoder 126 are sent to STB 22 via a system bus 130. A CPU 132 can thus access the decoded data from data decoder 126 via system bus 130. Video data decoded by video decoder 122 is passed to a graphics processor 136, which is optimized to process graphics information rapidly. Graphics processor 136 is particularly useful in processing graphic-intensive data associated with Internet browsing, gaming, and multimedia applications, such as those associated with Multimedia and Hypermedia information coding Experts Group (“MHEG”) STB applications. It should be noted, however, that the function of graphics processor 136 may be unnecessary in some STB designs having lower capabilities, and the function of graphics processor 136 may be handled by CPU 132 where decoded video is passed directly from video decoder 122. Graphics processor 136 is also coupled to system bus 130 and operates under the control of CPU 132.

STB 22 may incorporate a smart card reader 140 for communicating with a so-called “smart card”, often serving as a Conditional Access Module (“CAM”). The CAM typically includes an independent CPU along with associated RAM and ROM memory. Smart card reader 140 is used to couple system bus 130 of STB 22 to a smart card serving as a CAM (not shown). Such smart card based CAMs may be utilized for authentication of a user and authentication of transactions carried out by the user, as well as authorization of services and storage of authorized cryptography keys. For example, the CAM may be used to provide the key for decoding incoming cryptographic data for content that the CAM determines the user is authorized to receive.

STB 22 may operate in a bidirectional communication mode so that data and other information may be transmitted not only from HE 10 to the end user, or from ISP host 38 to the end user of STB 22, but also, from the end user upstream using an out-of-band channel. In accordance with an embodiment of the invention, such data passes through system bus 130 to a modulator 144, through tuner 102 (operating as a return path OOB tuner), and out through transmission medium 20. This capability is used to provide a mechanism for STB 22 and/or its user to send information to HE 10 (e.g. service requests or changes, registration information, payment transactions, etc.) as well as to provide fast outbound communication with Internet 44 or other services provided at HE 10 to the end user.

STB box 22 may include any of a plurality of Input/Output (“I/O”) interfaces represented by I/O interfaces 146 that permit interconnection of I/O devices to STB 22. By way of example, and not limitation, a serial RS-232 port 150 may be provided to enable interconnection to any suitable serial device supported by the internal software of STB 22. Similarly, communication with appropriately compatible devices may be provided via an Ethernet port 152, a Universal Serial Bus (“USB”) port 154, an IEEE 1394 or IEEE 1394 wide port 156, an S-video port 158, and an IR port 160. Such interfaces may be utilized to interconnect STB 22 with any of a variety of accessory devices, such as storage devices (not shown), A/V devices 26, gaming devices (not shown), Internet Appliances 28, etc., through interface 30.

I/O interfaces 146 may include a modem (be it dial-up, cable, DSL, or other technology modem) having a modem port 162 to facilitate high speed or alternative access to Internet 44 or other data communication functions. In one preferred embodiment, modem port 162 is that of a Data Over Cable System Interface Specification (“DOCSIS”) cable modem to facilitate high speed network access over a cable system, and port 162 is appropriately coupled to transmission medium 20 embodied as a coaxial cable. Thus, STB 22 can carry out bidirectional communication via the DOCSIS cable modem, with STB 22 being identified by a unique URL.

A PS/2 or other keyboard/mouse/joystick interface 164 may be provided to permit ease of data entry to STB 22. Such inputs provide the user with the ability to easily enter data and/or navigate using pointing devices. Pointing devices such as a mouse or joystick may also be used in gaming applications.

STB 22 may incorporate basic video outputs 166 that may be used for direct connection to TV 24, instead of (or in addition to) through, say, IEEE 1394 port 156 and interface 30. In accordance with an embodiment of the invention, video outputs 166 may provide composite video formatted as National Television System Committee (“NTSC”) video. Video output 166 may also be provided by a direct connection to graphics processor 136 or demultiplexer and descrambler circuit 110 rather than passing through system bus 130. S-Video signals of S-Video port 158 may be similarly provided without passing through system bus 130.

IR port 160 may be IR receiver 34, shown in FIG. 1, to receive commands from input device 36, which may be an IR remote control, an IR keyboard, or other IR control device. Although not explicitly shown, front panel controls may be included and connected through a port in I/O interfaces 146 to directly control the operation of STB 22. Additional interface may be provided in STB 22 in various combinations.

STB 22 may include a disc drive interface 170 and mass storage disc drive 172 for user storage of content and data as well as providing storage of programs operating on CPU 132. STB 22 may also include floppy disc drives, CD ROM drives, CD R/W drives, DVD drives, etc. CPU 132 is coupled through system bus 130 to memory 176. Memory 176 may include a combination any suitable memory technology including Random Access Memory (“RAM”), Read Only Memory (“ROM”), Flash memory, Electrically Erasable Programmable Read Only Memory (“EEPROM”), etc.

While the above exemplary system 100, including STB 22, is illustrative of the basic components of a digital STB suitable for use with the present invention, the architecture shown should not be considered limiting since many variations of the hardware configuration are possible without departing from the present invention.

In general, during operation of STB 22, an appropriate operating system 180, such as Sony Corporation's Aperios™ real time operating system, is loaded into, or is permanently stored in, active memory along with the appropriate drivers for communication with the various interfaces. Along with the operating system and associated drivers, STB 22 may operate using browser software 182 in active memory or may permanently reside in ROM or EEPROM. Browser software 182 may operate as the mechanism for viewing not only web pages on Internet 44, but may also serve as the mechanism for viewing an EPG formatted as a Hypertext Markup Language (“HTML”) document. Browser 182 may also provide the mechanism for viewing normal programming (wherein normal programming is viewed as an HTML video window—often occupying the entire area of screen 26). It is noted that Browser 182 and Operating System 180 may be included in memory 176 or disc drive 172.

STB software architectures may vary depending upon the operating system. However, various hardware interface layers are included at the lowest layer. It may include a next layer referred to as “middleware”. Such middleware permits applications to run on multiple platforms with little regard for the actual operating system in place. Middleware may be based upon JavaScript and HTML virtual machines. At the top layer is the application layer where user applications and the like reside (e.g. browsing, email, EPG, Video On Demand (“VOD”), rich multimedia applications, pay per view, etc.). The present invention may be utilized with any suitable STB software architecture.

As described above, system 100 provides for designating a presented program segment and retrieving data for the designated program segment in its entirety and related data according to an embodiment of the present invention. Exemplary processes for carrying out the invention will now be described in detail.

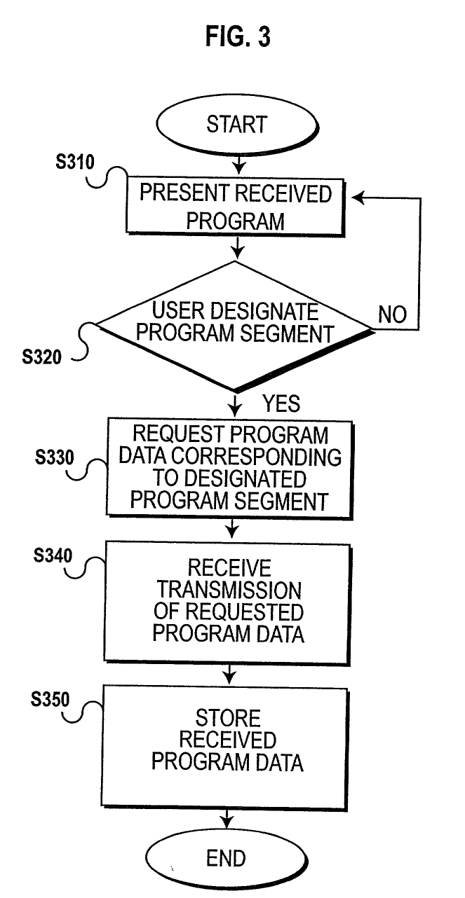

FIG. 3 illustrates a process for designating a presented program segment at STB 22 and retrieving data corresponding to the designated program segment (which may be a video clip of the program segment in its entirety) and related data in accordance with an embodiment of the present invention.

As shown in FIG. 3, at step S310, STB 22 is tuned to a programming channel broadcast from HE 10, say, a video music channel, on transmission medium 20 for receiving a program data signal and presenting the program on TV 24, A/V devices 27, and/or internet appliances 28. As described before, the program data signal may be received in a standard analog broadcast, or digital broadcast format, such as MPEG2, via transmission medium 20 from HE 10. The program data signal may also be received by TV 24 through a direct cable connection (not shown) or an antenna (not shown). The presented program may include a number of segments with corresponding identifiable clips (e.g., music video clips) stored at, e.g., media server 12. The program data signal may also include identification information such as a signal header (e.g., PID) for identifying each segment and/or each portion thereof.

As the program is being presented, control passes to step S320, where it is determined whether a user designates a program segment or a portion of a program segment being presented. For example, a music video program segment may include one or more music videos where each music video may form a portion of the program segment (i.e., a user may designate any one of the individual videos in a segment). A user's designation may be received from input device 36, any I/O devices connected to STB 22 via I/O interfaces 146, or may be directly input at a control panel (not shown) on STB 22, at any time during the presentation of the program segment (or a portion thereof).

If at step S320, the user does not select the program segment (or segment portion) presented (“NO”), the process returns to step S310 to continue presenting the program and monitoring the user inputs to determine whether the user makes a selection (step S320).

If at step S320, the presented program segment (or segment portion) is selected (“YES”) (i.e., STB 22 receives the designation (or request) at receiver 34, I/O interfaces 146, or control panel), control then passes to step S330 where STB 22 transmits a request for the program data (clip), in its entirety, corresponding to the designated program segment (or segment portion) to HE 10. The request may include the identification information (e.g., the PID) transmitted along with the program data for identifying the designated program segment (or segment portion). HE 10 processes the request and transmits the requested program data (clip) to STB 22. Alternatively, the request may include the time of the designation and the programming channel that STB 22 is tuned to for identifying the designated program segment (or segment portion).

At step S340, STB 22 receives a parallel transmission of the requested program data corresponding to the designated program segment (or segment portion), which may be in a different, more compressed format, such as MPEG4. The requested program data (clip) is then stored in disc drive 172, ready for playback, as illustrated by step S350. In accordance with an embodiment of the invention, data transmission for the requested program data may also be performed during a time when the user is not viewing any programming. STB 22 may store designation(s) received during a viewing session in disc drive 172 or memory 176, and request and receive the program data corresponding to the stored designation(s) when it is not presenting any programs to TV 24. STB 22 may query program listing database 18 on EPG server 16 for program segment information using the designation time(s) and programming channel(s), and request the program data using such information.

The requested program data may be downloaded in multiplexed format with a digital signal transmission or provided on a parallel transmission channel, such as one of a plurality of digital channels available on a high definition television channel. If the data is already being transmitted in a digital format, such as MPEG2, the data may be transcoded (converted directly from MPEG2 to MPEG4 without decoding) before being stored. Of course, the data may also be stored in the received native format. Furthermore, the user may be presented with a choice of format, which may include selecting a device for later playing back the requested program data. Memory 176 may act as a buffer memory when necessary, so that a user may select a program segment (or segment portion), say, a music video, to be stored at any point of the playing of the program segment (or segment portion). This may not be required if the program data (e.g. the corresponding music video clip) is to be transmitted to STB 22 in parallel, in its entirety, over a different transmission channel.

According to an embodiment of the invention, additional information related to the designated program segment (or segment portion) may be downloaded along with the requested program data. Such information may include program segment information such as the program title, featured artist(s), song title, album title, etc. It may also include commercial advertisements (e.g., album promotions and new releases for the featured artist(s) and/or other similar artists), other clips (e.g., music videos, artist interviews), concert dates, news regarding the artist(s) and other similar artists, etc. Such additional information may be updated periodically or after a number of playbacks of program data (e.g. a music video clip) by automatically designating the program data as a designated program segment and retrieving new information as described above.

Advertisement information may be attached to the program data for playback. For example, before or after each playback of a downloaded clip, a short commercial may be played back. Such advertisements may be selected based upon the artist and/or genre of a designated program segment (or segment portion, e.g., music video), sponsorship arrangements, user profiles (user viewing history, designation history, and the like), etc. A pricing model may be based upon actual views of a particular commercial or video music clip. Thus, advertising information may be added as an alternative to payment by the user. Furthermore, the user may be presented with a choice between paying a subscription fee, paying for each download, and accepting advertising. The subscription model may include the user paying for limited or unlimited downloads over a predetermined period of time.

Once requested program data (e.g., a music video clip) has been successfully downloaded, the user may then playback the program data (or clip) at any selected time, or corresponding to other events, such as playback of a corresponding CD, or playback of corresponding audio data by a radio station, or the like. For example, as mentioned before, additional information attached to the downloaded clip may indicate the artist name(s), song title, album title, etc. As such, STB 22 may determine, based upon such information, when a corresponding CD or corresponding audio data from a radio station is being presented, and automatically playback the downloaded program data (or clip). As noted before, updated information related to the clip may be searched for and retrieved each time the clip is played back.

In accordance with an embodiment of the invention, a clip may also be determined at playback of the corresponding CD, or playback of the corresponding audio data by a radio station, or the like. A user playing a CD in a standard CD player (A/V devices 26) may request the download of a video music clip (i.e. program data) corresponding to a song being listened to (i.e. designate the song as a designated program segment), or the videos may be automatically downloaded to STB 22 upon playing the song on the CD. Thereafter, the user may view the video upon playback of the audio through the CD player. The played back video need not be a conventional music video, but may also be any form of animation, or even interactive games or other programming related with broadcast audio or video data. Furthermore, designation of a program segment may take place in a PDA or the like upon reading or viewing an advertisement. An advertisement number could be input, or a barcode read. Upon uploading of this information, a related video clip may be downloaded.

In addition, the designation may be done using an emarker on, say, a radio broadcast of a song where the corresponding music video is downloaded in the manner described above. Designations may also be made using a barcode reader for reading barcodes on, say, a print advertisement where corresponding product and/or service information is downloaded. As mentioned before, STB 22 may be tuned to an audio cable channel for presenting an audio program on A/V devices 26 (e.g., a stereo system) where program data (e.g., a music video clip) corresponding to a designated song may be retrieved.

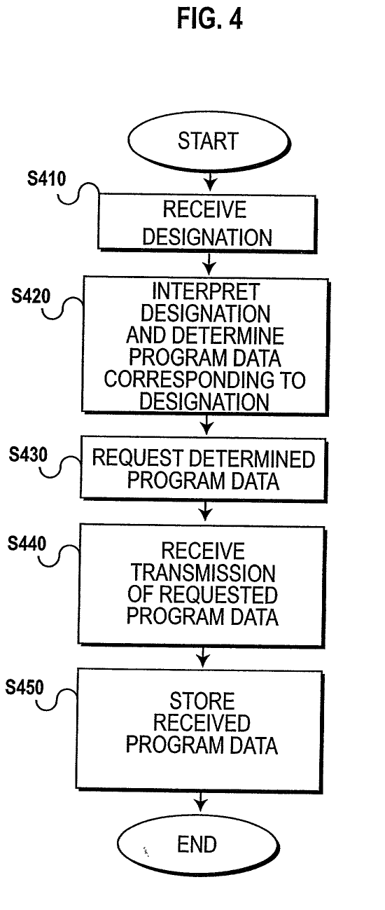

FIG. 4 illustrates a process for determining and downloading program data corresponding to a program segment (or a portion thereof) based upon a designation on the program segment (or segment portion).

As shown in FIG. 4, at step S410, STB 22 receives a designation from an external device. The designation may be made using input device 36 on a song while STB 22 is presenting audio programming from an audio cable channel or during an artist interview, advertisement, or other related content from HE 10. The designation may also be a playback if a song on a CD at A/V devices 26 (or a user designation thereof), a marker made using an emarker during a radio broadcast, a barcode scan of a print advertisement, etc.

After receiving the designation, control passes to step S420 where STB 22 interprets the designation and identifies program data (e.g., a video clip) corresponding to the designation. STB 22 may search for additional information in order to determine the program data. For example, STB 22 may determine the music video for an emarker designation by searching a radio station programming schedule/playlist for the song title and/or artist name. STB 22 may also search for related information data. Related information data may include concert dates, news regarding the artist and other similar artists, new releases by the artist and similar artists, other video clips from the same or other artists. STB 22 may search content database 52, Internet 44, remote server 48, and/or media server 12 for such additional information. It is noted that the designation may be transferred to, say, the user's PDA and/or PC to perform the interpretation and identification of step S420, after which program data (e.g., a video clip) information is forwarded to STB 22 before downloading.

Next, at steps S430 S440, and S450, STB 22 requests, receives, and stores the program data in a manner similar to steps S330, S340, S350, respectively, as described above. As also described before, additional information may be received and updated upon each playback of the program data (e.g., a video clip).

According to an embodiment of the invention, the data may be stored off site at a remote storage device, such as a storage account assigned to the user and provided at remote server 48 via Internet 44 (e.g., Xdrive), and streamed to STB 22 upon selection.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therein.

What is claimed is:

1. A method for designating a video clip to be downloaded, comprising the steps of:
receiving a designation signal while a program segment is being output;
determining a video clip corresponding to a portion of said program segment upon receipt of said designation signal; and
downloading said determined video clip.

2. The method of claim 1, wherein said determined video clip is downloaded to a set top box for future playback.

3. The method of claim 1, wherein said portion of said program segment is a music video.

4. The method of claim 1, wherein said determined video clip is downloaded and played back employing a device other than a set top box.

5. The method of claim 1, wherein said portion of said program segment comprises an audio music program segment.

6. The method of claim 1, wherein said portion of said program segment comprises an audio music program segment from a compact disc (CD).

7. The method of claim 1, wherein said portion of said program segment comprises an audio music program segment from a radio station.

8. The method of claim 1, wherein said portion of said program segment comprises an audio music program segment from an audio cable channel.

9. The method of claim 1, wherein said portion of said program segment comprises a print advertisement.

10. The method of claim 1, wherein said portion of said program segment comprises a computer program.

11. The method of claim 1, further comprising the step of automatically determining one or more commercials corresponding to said determined video clip.

12. The method of claim 11, wherein said one or more commercials are determined based upon a viewing history of a user.

13. The method of claim 11, wherein said one or more commercials are determined based upon a designation history of a user.

14. The method of claim 11, wherein said one or more commercials are stored on a storage device.

15. The method of claim 1, further comprising the step of downloading data relating to said portion of said program segment.

16. The method of claim 1, further comprising the step of storing said downloaded determined video clip.

17. The method of claim 16, wherein said downloaded determined video clip is stored in a set top box.

18. The method of claim 1, further comprising the step of determining a format for said determined video clip.

19. The method of claim 18, wherein the downloading step downloads said determined video clip in the determined format.

20. The method of claim 18, further comprising the step of converting the downloaded determined video clip to the determined format.

21. The method of claim 18, further comprising the step of receiving a format selection for said determined video clip, and wherein the format determining step determines the format based upon the format selection.

22. An apparatus for receiving and replaying a video clip, comprising:
a designation interpreter for receiving a designation signal while a program segment is being output;
a determination device for determining a video clip corresponding to a portion of said program segment upon receipt of said designation signal; and
a receiving device for downloading said determined video clip.

23. The apparatus of claim 22, wherein said apparatus is a set top box.

24. The apparatus of claim 22, wherein said portion of said program segment comprises a video music clip.

25. The apparatus of claim 22, wherein said determined video clip is downloaded and played back employing a device other than a set top box.

26. The apparatus of claim 22, wherein said portion of said program segment comprises an audio music program segment.

27. The apparatus of claim 22, wherein said portion of said program segment comprises an audio music program segment from a compact disc (CD).

28. The apparatus of claim 22, wherein said portion of said program segment comprises an audio music program segment from a radio station.

29. The apparatus of claim 22, wherein said portion of said program segment comprises an audio music program segment from an audio cable channel.

30. The apparatus of claim 22, wherein said portion of said program segment comprises a print advertisement.

31. The apparatus of claim 22, wherein said portion of said program segment comprises a computer program.

32. The apparatus of claim 22, further comprising a device for automatically determining one or more commercials corresponding to said determined video clip.

33. The apparatus of claim 32, wherein said one or more commercials are determined based upon a viewing history of a user.

34. The apparatus of claim 32, wherein said one or more commercials are determined based upon a designation history of a user.

35. The apparatus of claim 32, wherein said one or more commercials are stored on a storage device.

36. The apparatus of claim 22, wherein said receiving device downloads data relating to said portion of said program segment.

37. The apparatus of claim 22, further comprising a storage device for storing said downloaded determined video clip.

38. The apparatus of claim 22, further comprising a device for determining a format for said determined video clip.

39. The apparatus of claim 38, wherein the receiving device downloads said determined video clip in the determined format.

40. The apparatus of claim 38, further comprising a device for converting the downloaded determined video clip to the determined format.

41. The apparatus of claim 38, further comprising a device for receiving a format selection for said determined video clip, wherein the device for determining the format determines the format based upon the format selection.

42. The apparatus of claim 22, wherein said downloaded determined video clip is stored in a set top box.

43. A method for designating a program segment to be downloaded, comprising the steps of:
receiving a designation signal while a program segment is being output;
transmitting a request for a video clip corresponding to a portion of said program segment upon receipt of said designation signal; and
downloading said video clip.

44. An apparatus for receiving and replaying a video clip, comprising:
a designation interpreter for receiving a designation signal while a program segment is being output;
a transmitting device for transmitting a request for a video clip corresponding to a portion of said program segment upon receipt of said designation signal; and
a receiving device for downloading said video clip.

45. A set of computer program instructions for designating a video clip to be downloaded, comprising:
an instruction for receiving a designation signal while a program segment is being output;
an instruction for determining a video clip corresponding to a portion of said program segment upon receipt of said designation signal; and
an instruction for downloading said determined video clip.

46. A set of computer program instructions for designating a program segment to be downloaded, comprising:
an instruction for receiving a designation signal while a program segment is being output;
an instruction for transmitting a request for a video clip corresponding to a portion of said program segment upon receipt of said designation signal; and
an instruction for downloading said video clip.

47. A storage medium storing instructions which, when executed on a programmed processor residing in a television set-top box, carry out the steps of:
receiving a designation signal while a program segment is being output;
determining a video clip corresponding to a portion of said program segment upon receipt of said designation signal; and
downloading said determined video clip.

48. A storage medium storing instructions which, when executed on a programmed processor residing in a television set-top box, carry out the steps of:
receiving a designation signal while a program segment is being output;
transmitting a request for a video clip corresponding to a portion of said program segment upon receipt of said designation signal; and
downloading said video clip.

49. A method for designating a video clip to be downloaded, comprising the steps of:
receiving a designation signal while a broadcast music video segment having an identifier corresponding to a video clip is being output;
obtaining a complete version of said video clip corresponding to said identifier upon receipt of said designation signal; and
downloading said complete version of said video clip.

50. The method of claim 49, wherein the complete version is obtained regardless of when during the broadcast video segment the designation signal is received.

51. An apparatus for receiving and replaying a video clip, comprising:
a designation interpreter for receiving a designation signal while a broadcast music video segment having an identifier corresponding to a video clip is being output;
a device for obtaining a complete version of said video clip corresponding to said identifier upon receipt of said designation signal; and
a receiving device for downloading said complete version of said video clip.

52. The apparatus of claim 51, wherein the complete version is obtained regardless of when during the broadcast video segment the designation signal is received.
